(19) United States
(12) Patent Application Publication
(10) Pub. No.: US 2005/0188863 A1
(43) Pub. Date: Sep. 1, 2005

(54) Metal extrusion press, in particular a horizontal metal extrusion press

(76) Inventors: Karl Hermann Claasen, Moers (DE); Uwe Muschalik, Duisburg (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/515,901

(22) PCT Filed: May 15, 2003
(86) PCT No.: PCT/DE03/01574

§ 371 Date: Nov. 23, 2004

(30) Foreign Application Priority Data
May 24, 2002 (DE) 10222951.1

(51) Int. Cl. B30B 12/00

(52) U.S. Cl. 100/299

(57) ABSTRACT

The invention relates to a metal extrusion press (1), in particular a horizontal metal extrusion press (1), comprising a charging device (7) for charging an ingot to be extruded (6) into an ingot receptacle. According to the invention, the charging device (7) brings an ingot (6) that is received in a charging position and held in a charging tray (18) into the centre or the axis (8) of the extrusion press in order to insert it into the ingot receptacle. The charging device (7) of said metal extrusion press comprises an ingot insertion unit (28) which contains two intercoupled motion-dependent sliding cylinders (29a, 29b). Said cylinders (29a, 29b) are fixed by their piston-rod heads (31a, 31b) to a linear guided insertion finger (25) and their cylinder bases are likewise pivotally mounted in bearing rings (30a, 30b).

The invention relates to a metal-extrusion press, in particular a horizontal metal-extrusion press, with a loading device for loading a billet to be extruded into a billet holder, the loading device moving a billet held in a loading shell from a loading position into the press middle in axial alignment with the billet holder.

Such a press with a loading device set up as a pivotal loader, as opposed to a standard linear loader, is known from EP 0,791,413. The swing arm here having a loading shell or a similar loading element such as a rack or sleeve is moved from a load-receiving position into an intermediate position and then into alignment with the press axis. In order to eliminate problems with its movement it is necessary to exactly control the positions of the loading shell or the like. In order to attain the fastest possible cycling time for loading a billet the swing arm is dimensioned for the pivot angle between the intermediate position and the press axis and is formed as a satellite swing arm. This satellite swing arm can move pivotally between the load-receiving position and the intermediate position with a base part, and the segment swing arm can move either synchronously or with a time delay relative to the base part. The satellite arm guided on the base part is moved by a motor and drive with a pinion relative to the base part. The billet positioned in the middle of the press is pushed by a slider into the billet holder of the extrusion press. The slider pushing the billet thus must be brought or shifted separately into position once the pivotal loader is in the intermediate position.

EP 0,428,989 describes a billet loader with special fork-like loading shells each mounted on a separate swing arm, the two swing arms being fixed on a shaft but one of the swing arms is axially shiftable on the shaft by means of a piston-cylinder unit. A billet heated in a furnace to extrusion temperature is picked up by the loading shells and is brought into position by the swing arms on the press axis in the open space between the die and the pushing plate. A cylinder shifts the machine frame with the billet holder toward the die so that the billet holder engages over the billet. Depending on the advance of the block holder the axially movable swing arms are shifted on the shaft until the billet is clamped between the press ram and the counter beam or a die held in a holder. The swing arms with the loading shells can then be swung back for a new loading operation. This loading operation absolutely requires the press ram.

It is an object of the invention to provide such an extrusion press with a pivotal loader that can be used in different applications and where the loading operation is independent of the press ram.

This object is attained in that the loading device is provided with a billet pusher having two synchronously operated and coupled loading cylinders that have piston-rod heads fixed to a linearly guided pusher finger and cylinder eyes that are also pivotally mounted. The two loading cylinders that are integrated into the loading device, preferably in a common support frame fixed on the loading device, make it possible as a result of their connection to the pusher finger to form a lever mechanism with a rocking movement during advance and retraction of the pusher finger about pivots at the bases of their cylinders. Thus with the controlled linear guiding of the pusher finger and the linked pushing of the billet into the billet holder there is a temporary physical offset of the loading cylinders which have to start with a V-shape open away from the pusher finger.

Thus during forward advance of the pushing finger the loading cylinder remote from the billet holder extends its cylinder rod and moves into an angled position while pivoting about its pivot on the floor and the other cylinder moves exactly oppositely. Its angled position in the starting position of the pushing finger with its piston rod extended changes with retraction of the piston rod until it is in an upright position. This happens at the end of the pushing operation when the pushing finger is at the billet holder. This alternation repeats with each return of the pushing finger to the starting position and with each new loading operation. In order to push the billet into the billet holder it is not necessary to move the running beam of the press and the press ram. They are replaced according to the invention by the loading-cylinder assembly together with the pusher finger which fits on a pivotal or even a linear loader like a back pack to move into position upstream of the billet holder.

An embodiment of the invention proposes that the loading shell be pivotally mounted on the loading-cylinder support frame. In the load-receiving position the loading shell takes on and holds a metal billet heated in a furnace to the extrusion temperature and is pivoted so as to grip the billet over most of its circumference. In the same manner after pushing of the billet into the billet holder it is pivoted downward so that the billet can immediately be pushed in.

According to an embodiment of the invention the piston rods of floor-pivoted cylinders mounted on the loading device engage the loading shell. In order to load a billet there is therefore a compact assembly having all the necessary parts and suitable for retrofitting to a standard billet loader. It is also possible to deal with very long billets in the extrusion press.

According to an embodiment of the invention the loading shell has a plurality of rails spaced at equal angles. To this end it is desirable that inner faces of the rails turned toward the billet are provided with rollers. The rollers allow low-friction feeding of the billet from the loading shell into the billet holder. The distribution of the rails ensures good containment of the billet at multiple points along a line.

When in addition to the rails on the loading shell there is a roller-equipped rail stationarily mounted on the loading-cylinder support frame, the surface surrounding the billet is advantageously increased.

A pivotal loading device according to a further embodiment advantageously is operated by pivot cylinders provided below the press frame and extending transversely of the press middle. These move the loading-cylinder support frame provided longitudinally adjacent the extrusion press from the load-receiving position into the press middle, to which end the pivotal loader is mounted on a fixed pivot axis.

Further features and particularities of the invention are seen in the claims and the following description of an embodiment of the invention shown in the drawing for an extrusion press with a pivotal loader as loading device. Therein:

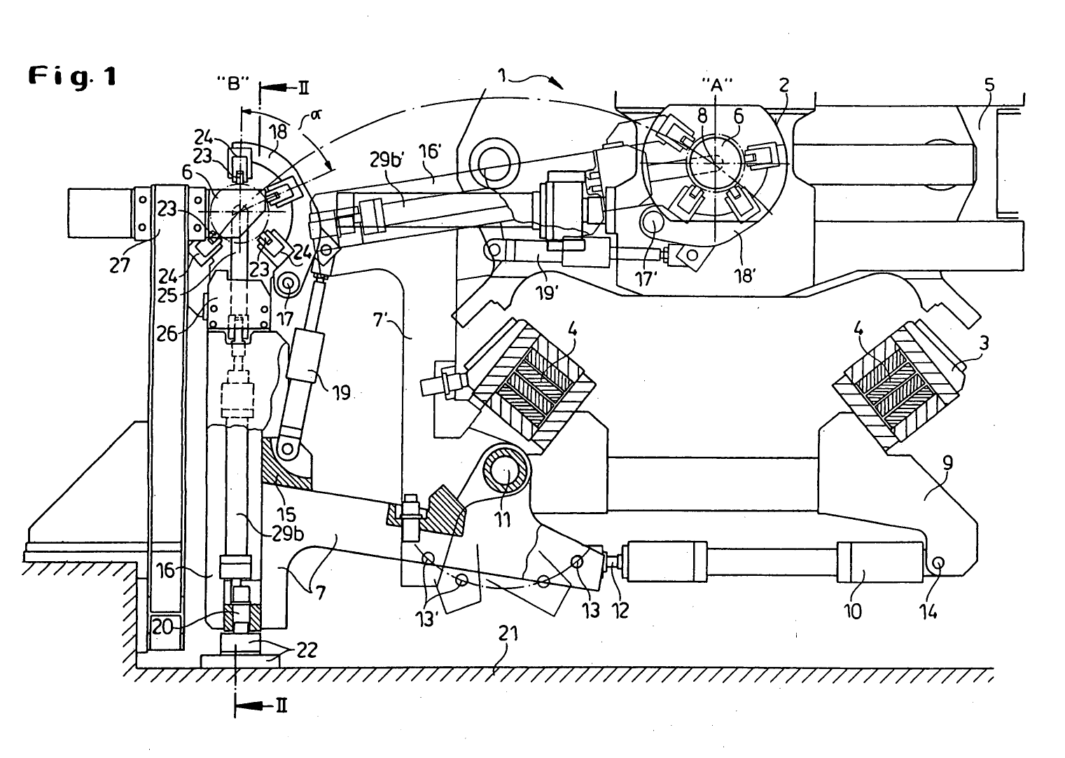

FIG. 1 is a partial cross section through a n extrusion press shown a die holder mounted on a counter beam and a pivotal loader shown from the side in its billet-pickup or -dropoff position;

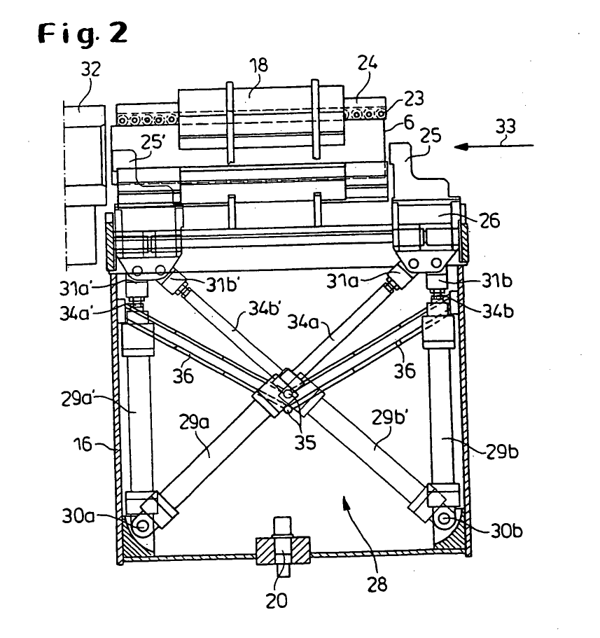

FIG. 2 is a detailed section through the pivotal loader taken along line II-II of FIG. 1.

As shown in FIG. 1 a standard metal-extrusion press 1 has a counter beam 5 connected via anchors 4 with an unillustrated cylinder beam set above the drawing plane and provided in a press frame 3 with a die holder shown at 2. A billet-holder support carrying a billet holder is provided on the press frame 3 for forcing a billet toward the die holder 2. The unillustrated running beam carries a press ram that pushes the billet held in the billet holder through the die of the die holder 2.

In order to load a billet 6 into the billet holder, the metal-extrusion press according to the embodiment is provided with a pivotal loader 7 that is pivoted about an axis 11 by cylinders 10 provided underneath the press frame 3 and extending transversely of the press center or axis 8 in a traverse 9. The cylinders 10 have piston rods 12 connected at 13 with the pivotal loader 7 and anchor pivots 14 on the traverse 9.

The pivotal loader 7 is formed on its free end projecting out of the press frame 3 as a sort of hammer head 15 on which is fixed a support frame 16 (see FIG. 2) that projects well above the hammer head 15 of the pivotal loader 7 in a load-receiving position B shown in FIG. 1. Actuators 19 are secured by their cylinders at one end to the hammer head 15 and by their piston rods to a sickle-shaped loading shell 18 carried on a pivot 17 of the support frame 16.

The lower end of the support frame 16 sits via a damping member 20 on a support 22 fixed on the floor 21. An upper end of the support frame 16 remote from the floor 21 has a stationary rail 24 provided on its upper surface with rollers 23. It works together with rails 24 also having rollers 23 spaced at angles α on the loading shell 18 in order to contain the billet 6 about as much of its circumference as possible and the hold it solidly in spite of its considerable unsupported, that is unclamped, regions. An upper end of the support frame 16 has a pusher finger 25 mounted on a guide block 26. The billet 6 is fed to the loading shell 18 in the load-receiving position B by an upstream guide 27.

The pusher finger 25 with the guide block 26 is part of a billet pusher 28 mounted on the support frame 16 and shown in more detail in FIG. 2. It also has two loading cylinders 29a and 29b having lower-end cylinder eyes 30a and 30b pivoted on the support frame 16 and piston-rod heads 31a and 31b on the guide block 26 of the pusher finger 25. FIG. 2 shows to the left of the support frame 16 with its billet pusher 28 a billet holder 32 of the extrusion press into which the billet 6 is pushed before it is forced by a press ram (not shown) through the die of the die holder 2 (see FIG. 1).

In order to push the billet 6 into the billet holder 32, the guide block 26 is shifted with the pusher finger 25 linearly as shown by the arrow, with the billet 6 moving with little friction on the rollers 23 of the rails 24 of the loading shell 18 into the billet holder 32. To do this the piston rods 34a and 34b of the feed cylinders 29a and 29b forming a V open away from the block 26 are operated oppositely, that is the piston rod 34b is extended from its cylinder while the piston rod 34a is synchronously retracted into the FIG. 2 loaded position where the parts have primes.

Guiding of the parts is improved when the loading cylinders 29a and 29b have follower bolts 35 riding in guides 36. After loading of the billet 6 into the billet holder 32, the billet loader 28 is reversed and the loading cylinders 29a and 29b are moved oppositely back into the starting position shown on the right on FIG. 2 in which the pusher finger 25 is upstream of the loading shell 18.

Pivoting of the loader 17 with its frame 16 holding a billet 6 in the loading shell 18 into the loading position in which the billet 6 is aligned with the die holder 2 and the billet holder 32 (as shown in FIG. 2) is shown in FIG. 1. The reference numerals with primes show the parts in their various positions, the reference numerals without primes showing the starting position. Thus when the cylinders 10 are actuated, the pivotal loader 7 with its support frame 16 carrying the billet pusher 28 moves from the load-receiving position B into push-out position A in which the billet 6 is aligned with the press axis 8 as described above. During the pivoting the pivotal loader 7 moves about the axis 11 by a definite arc. After loading the billet 6 into the billet holder 32 (FIG. 2) the loading shell 18′ is swung down about its pivot axis 17′ so that, during the reverse pivoting of the pivotal loader 7′ into its starting position for the loading position B, the running beam with the press ram (not shown) can move in the direction to force the billet 6 into the die holder 2.

1-8. (canceled)

9. In combination with a metal extrusion press in which a billet aligned with a press axis and fitted axially into an end of a billet holder prior to extrusion, an apparatus comprising:
a loading device having a seat adapted to receive the billet and displaceable between a load-receiving position holding the billet adjacent the press offset from the axis and a loading position holding the billet in the press axially aligned with the billet holder;
a pusher on the loading device axially aligned with the seat;
guide means for supporting the pusher on the loading device for movement in the loading position linearly and axially toward and away from the billet holder;
two separate expansible loading cylinders each having an anchored end and an opposite end pivoted on the pusher; and
means for synchronously and alternately operating the cylinders to move the pusher along the guide means toward the billet holder and thereby push the billet in the seat in the loading position into the billet holder.

10. The apparatus defined in claim 9 wherein the device has a frame carrying the pusher, guide means, and loading cylinders, the loading cylinders each being pivotally anchored at one end on the frame.

11. The apparatus defined in claim 10 wherein the loading cylinders extend at an acute angle to each other.

12. The apparatus defined in claim 10 wherein the loading device is provided with a loading shell pivoted on the frame and forming the seat.

13. The apparatus defined in claim 12, further comprising
actuators for pivoting the loading shell on the frame between a holding position securing the billet in the seat and a freeing position permitting the billet to move freely into and out of the seat.

14. The apparatus defined in claim 12 wherein the loading shell is provided with a plurality of guide rails extending parallel to the axis.

15. The apparatus defined in claim 12 wherein the loading shell is provided with a plurality of rows extending parallel to the axis of rollers.

16. The apparatus defined in claim 9, further comprising
means including actuators for pivoting the loading device about an axis parallel to the press axis between the load-receiving and loading positions.
